(19) United States
(12) Patent Application Publication
(10) Pub. No.: US 2024/0108165 A1
(43) Pub. Date: Apr. 4, 2024

(54) A MACHINE FOR PREPARING BEVERAGES COMPRISING A SENSORISED ACCESSORY WITH RF TRANSMISSION OF THE VALUE MEASURED OF THE TEMPERATURE OF A LIQUID IN A CONTAINER

(71) Applicant: DE' LONGHI APPLIANCES S.R.L., Treviso (IT)

(72) Inventors: Paolo EVANGELISTI, Treviso (IT); Alberto ACCIARI, Treviso (IT); Nicola PIOVAN, Treviso (IT)

(73) Assignee: DE' LONGHI APPLIANCES S.R.L., Treviso (IT)

(21) Appl. No.: 17/769,178

(22) PCT Filed: Sep. 30, 2020
(86) PCT No.: PCT/EP2020/077392

§ 371 Date: Apr. 14, 2022

(30) Foreign Application Priority Data
Oct. 16, 2019 (IT) 102019000019064

(51) Int. Cl. A47J 31/52; A47J 31/44; G01K 1/024; G01K 1/14; G01K 13/00

(52) U.S. Cl. CPC A47J 31/5253; A47J 31/4489; A47J 31/521; G01K 1/024; G01K 1/14; G01K 13/00; A47J 2202/00

(57) ABSTRACT

A machine for preparing beverages comprises a front wall, a rest base for containers positioned in front of the front wall and a temperature detection probe immersible in a comestible liquid contained in a container positioned on the rest base. The front wall has a beverage dispenser and a steam dispenser positioned above the rest base of the containers and supports a first antenna. The temperature probe comprises a second antenna interacting with the first antenna for wireless transmission of the temperature detected of the liquid in the container.

### CROSS-REFERENCE TO RELATED APPLICATIONS

This is a U.S. national phase application under 35 U.S.C. § 371 of International Patent Application No. PCT/EP2020/077392, filed Sep. 30, 2020, and claims benefit of priority to Italian Patent Application No. 102019000019064, filed Oct. 16, 2019. The entire contents of these applications are hereby incorporated by reference.

### TECHNICAL FIELD

The present invention relates to a machine for preparing beverages comprising a front wall, a rest base for containers positioned in front of the front wall and a temperature detection probe immersible in a comestible liquid contained in a container positioned on the rest base, where the front wall has a beverage dispenser and a steam dispenser positioned above the rest base for containers of the containers and supports a first antenna, and the temperature probe comprises a second antenna interacting with the first antenna for wireless transmission of the temperature detected of the liquid in the container.

The market has for many years offered machines for the preparation of beverages, typically coffee machines, which have sensors for detecting the temperature of liquids used for making and/or infusion of the beverage.

It is known that the detection of the temperature of liquids is of very great importance for the preparation of beverages and/or infusions.

Coffee machines (W02018/2013866) are known having temperature sensors that rest on outer walls of containers: these sensors are notoriously poorly efficient, as they carry out indirect and approximate measurements of the temperature of the liquid contained.

Also known are coffee machines (EP2584906, EP1776905) having temperature sensors which carry out a direct and therefore precise measurement of the liquid in the container, but these have complex mechanical systems for managing the temperature reading wand and the relative sensor cable inside the wand.

There is therefore a widely felt need to simplify the structure of coffee machines with known sensors for detecting the temperature of liquids used for making and/or infusion of the beverage.

The technical task of the present invention is, therefore, to realise a machine for preparing beverages, typically a coffee machine with a sensor for detecting the temperature of liquids used for making and/or infusion of the beverage which enables obviating the technical disadvantages comprised in the prior art.

Within the context of this technical task an object of the invention is to realise a coffee machine with a sensor for detecting the temperature of liquids used for making and/or infusion of the beverage which enables reading the temperature of the liquid both in the cold container and during the preparation, as well as following the preparation of the beverage. A further aim of the invention is to realise a coffee machine with a sensor for detecting the temperature of liquids used for making and/or infusion of the beverage which acquires the temperature automatically.

A further aim of the invention is to realise a sensor which operates with a low energy consumption to detect the temperature of liquids used for making and/or infusion of the beverage.

The technical task, as well as these and other aims, according to the present invention, are attained with a machine for preparing beverages, typically a coffee machine, comprising a front wall, a rest base for containers positioned in front of the front wall and a temperature detection probe immersible in a comestible liquid contained in a container positioned on the rest base, where the front wall has a beverage dispenser and a steam dispenser positioned above the rest base for containers of the containers and supports a first antenna, and the temperature probe comprises a second antenna interacting with the first antenna for wireless transmission of the temperature detected of the liquid in the container.

Other characteristics of the present invention are also defined in the following claims.

### BRIEF DESCRIPTION OF THE DRAWINGS

Further characteristics and advantages of the invention will become more apparent from the description of a preferred, but not exclusive, embodiment of a machine for preparing beverages, typically a coffee machine, comprising a sensor for detecting the temperature of liquids used for making and/or infusion of the beverage according to the invention, illustrated by way of indicative and non-limiting example in the accompanying drawings, in which:

FIG. 1 illustrates a coffee machine with a temperature detection probe;

FIG. 2 illustrates a coffee machine with a temperature detection probe and a steam wand positioned in a container of liquids, in particular a cup for milk;

FIG. 3 illustrates a coffee machine with a temperature detection probe, a coffee dispenser and a milk dispenser positioned in a container of liquids, in particular a cup for cappuccino or caffelatte;

FIGS. 4a and 4b illustrate a view and a section of the temperature detection probe, while FIG. 4c is a view of the electronic board incorporated in the temperature detection probe;

FIG. 5 shows a lateral elevation view of the coffee machine equipped with a temperature probe having an upper end profiled so as to hook the upper edge of the cup.

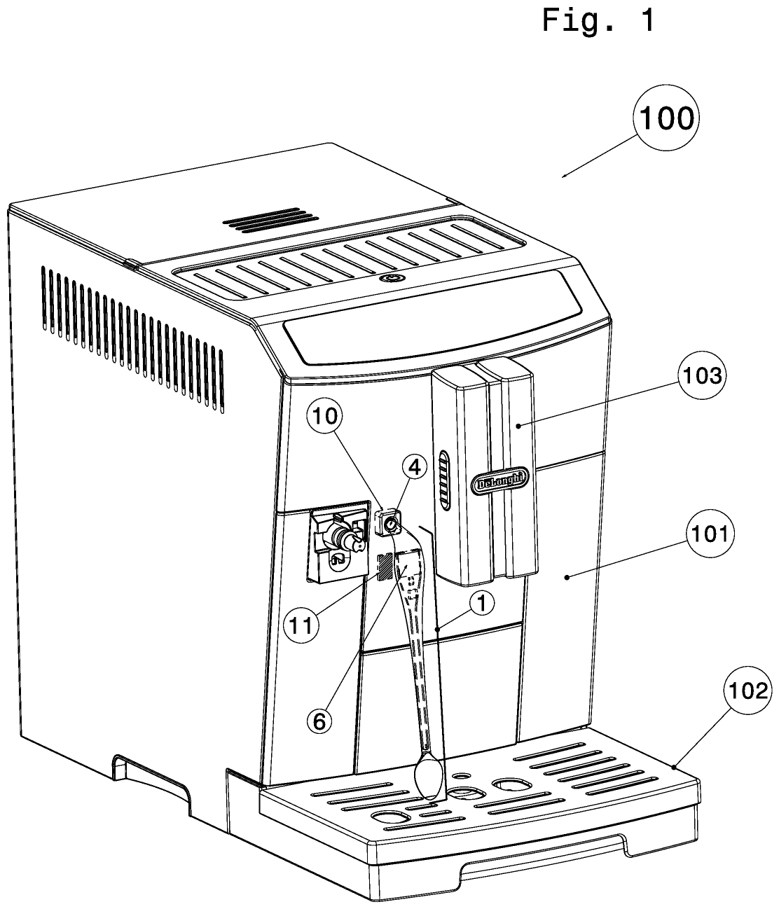

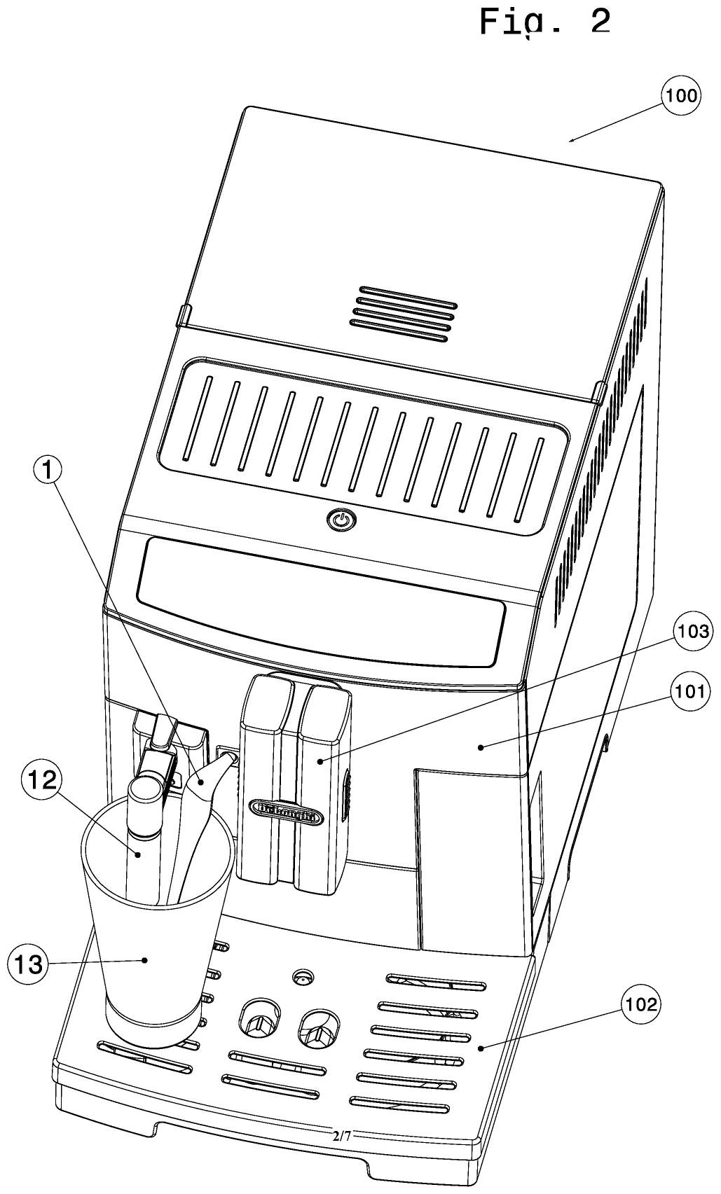

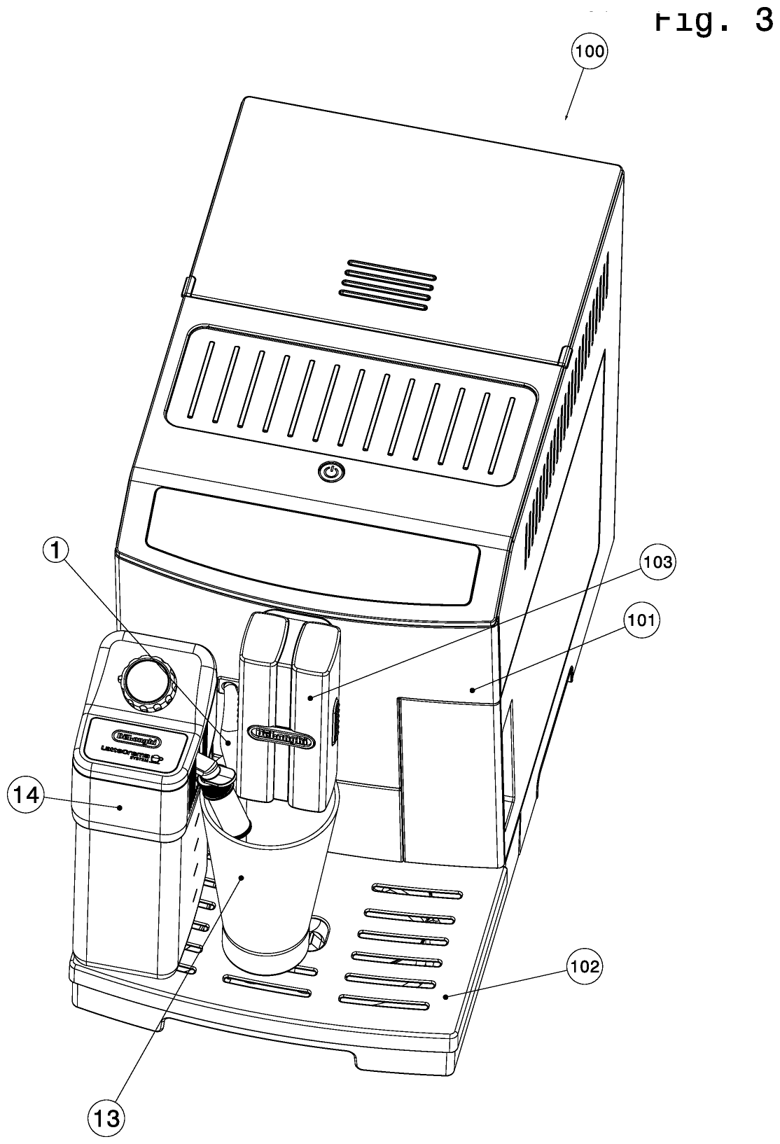

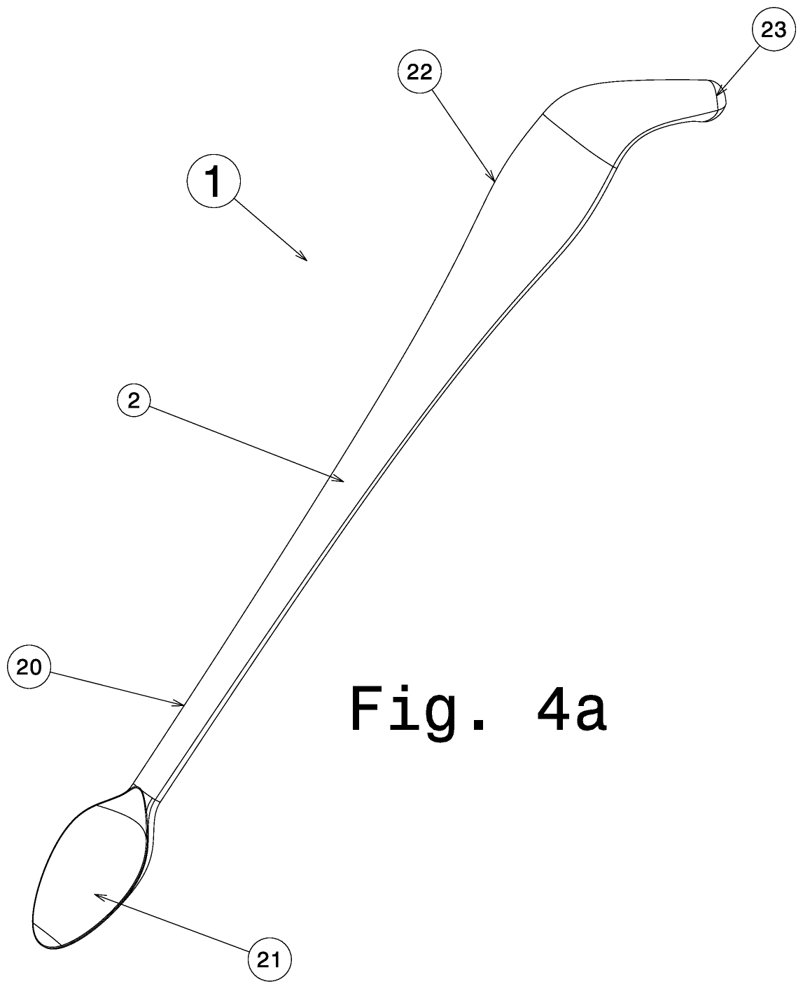

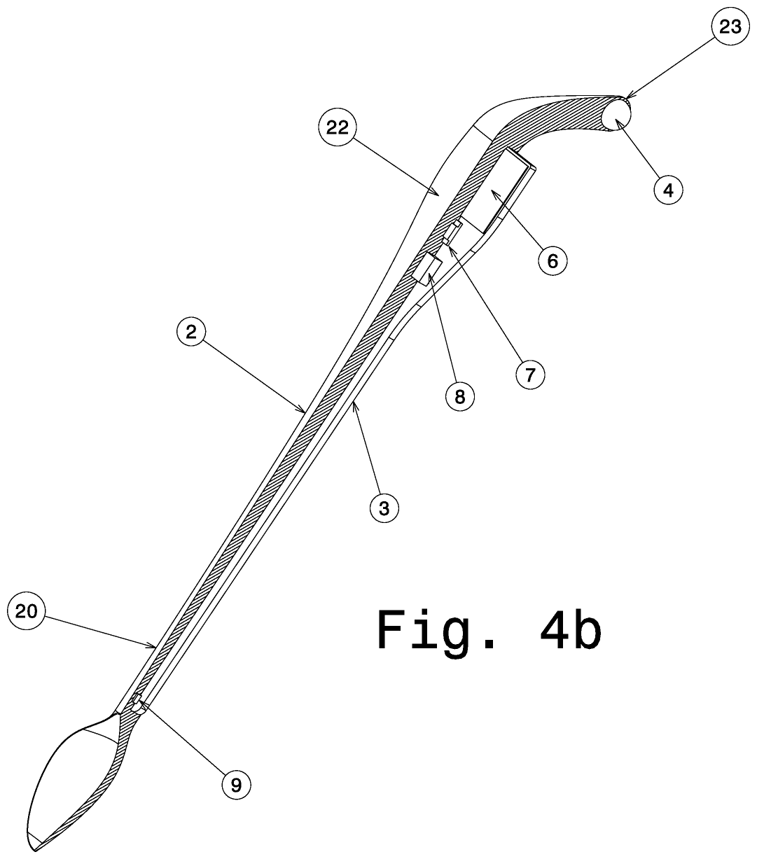

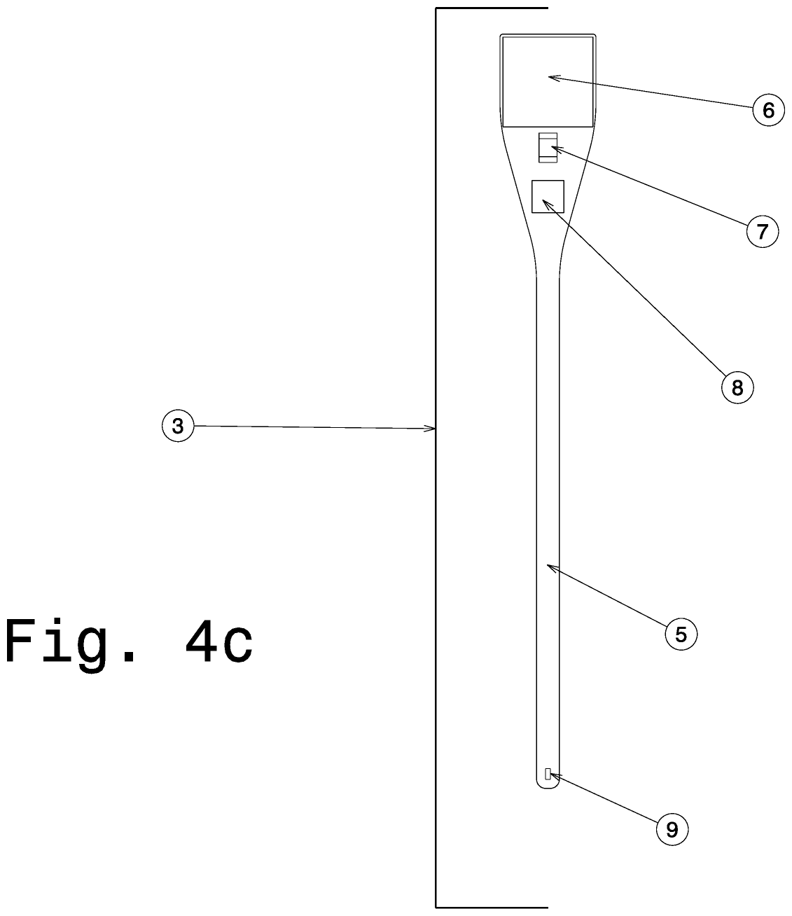

With reference to the appended figures, a coffee machine is shown with a temperature detection probe, indicated in its entirety by reference number 100.

The coffee machine 100 has a front wall 101, a rest base for containers 102 positioned in front of the front wall 101 and a temperature detection probe 1 immersible in a comestible liquid contained in a container 13 positioned on said rest base 102.

The front wall 101 has a beverage dispenser 103, especially of coffee, and a steam dispenser 12 positioned above the rest base for containers 102.

The front wall 101 supports a first antenna 11 on the machine side, and the temperature probe 1 comprises a second antenna 6 interacting with the first antenna 11 for wireless transmission, typically using RFID technology, of the temperature detected of the liquid in the container 13.

The temperature probe 1 comprises a longitudinal body 2 which incorporates a temperature sensor 9, a microprocessor 8 and a passive transponder 7 including the second antenna 6 with technology typically of an RFID type.

The coffee machine 100 is equipped with a power supply board (not shown in the drawings) for the passive transponder 7.

The longitudinal body 2 of the temperature probe 1 has a lower portion 20 including the lower end 21, and an upper portion 22 including the upper end 23.

The temperature sensor 9 is positioned at the lower portion 20 and the second antenna 6 is positioned at the upper portion 22.

The longitudinal body 2 further has support means 4 of the temperature probe 1 engageable with the front wall 101 or with the container 13.

The support means 4 are advantageously positioned at the upper end 23 of the upper portion 22 and are magnetic or mechanical.

In the illustrated case, the support means 4 disengageably hook manually to the front wall 101 at a fixed magnetic coupling 10.

The magnetic support means 4 of the temperature probe 1 advantageously have a convex spherical shape and the fixed magnetic coupling 10 on the front wall 101 has a complementary concave spherical shape.

When the probe 1 is in use, the support means 4 advantageously positions the second antenna 6 outside the container 13 and facing in front of the first antenna 11.

The first antenna 11 is positioned at a greater height than the tallest height of the container 13 positionable on the container rest base 102, beneath the beverage dispenser 103.

The first antenna 11 is further interposed between the beverage dispenser 103 and the steam dispenser 12.

The adjacent arrangement of the two antennas 6, 11 without interposed barriers enables limitation, to an indispensable minimum, of the transmission power of the antennas and therefore also of the energy that the second antenna 6 has to transfer to the first antenna 11 for the power supply to the temperature detection probe 1.

The temperature sensor 9 is positioned at the lower portion 20 of the longitudinal body 2, but in a longitudinally retracted position with respect to the lower end 21, advantageously configured as a tool, for example a coffee spoon.

The microprocessor 8 and the passive transponder 7 and the second antenna 6 are positioned at the upper portion 22, but in a longitudinally retracted position with respect to the upper end 23.

The temperature sensor 9, the microprocessor 8 and the passive transponder 7 and the second antenna 6 in the longitudinal body 2 are supported by a printed interconnection circuit 5, together constituting the electronic board 3, advantageously made of a flexible material.

The electronic board 3 is sealed inside the longitudinal body 2 of the temperature probe 1, advantageously made of a plastically deformable flexible material.

The functioning of a machine for preparing beverages, typically a coffee machine, according to the invention is obvious from what is described and illustrated, and, in particular, is substantially as follows.

When the machine is switched on, the detection and reading system of the temperature—among others—is activated by the temperature sensor 9 inside the temperature probe 1.

The temperature probe 1 is disengageably hooked, via the magnetic support means 4, to the fixed magnetic coupling 10: the complementary spherical convex shape of the support means 4 and the spherical concave shape of the fixed magnetic coupling 10 advantageously enable manual relative rotation of the temperature probe engaged on the front wall 101 of the machine, and facilitate easy insertion thereof into the container 13 positioned on the rest base 102, i.e. in the liquid contained therein.

When the probe 1 is thus positioned and in use, the support means 4 engaged in the fixed magnetic coupling 10 positions the second antenna 6 outside the container 13 and facing the first antenna 11.

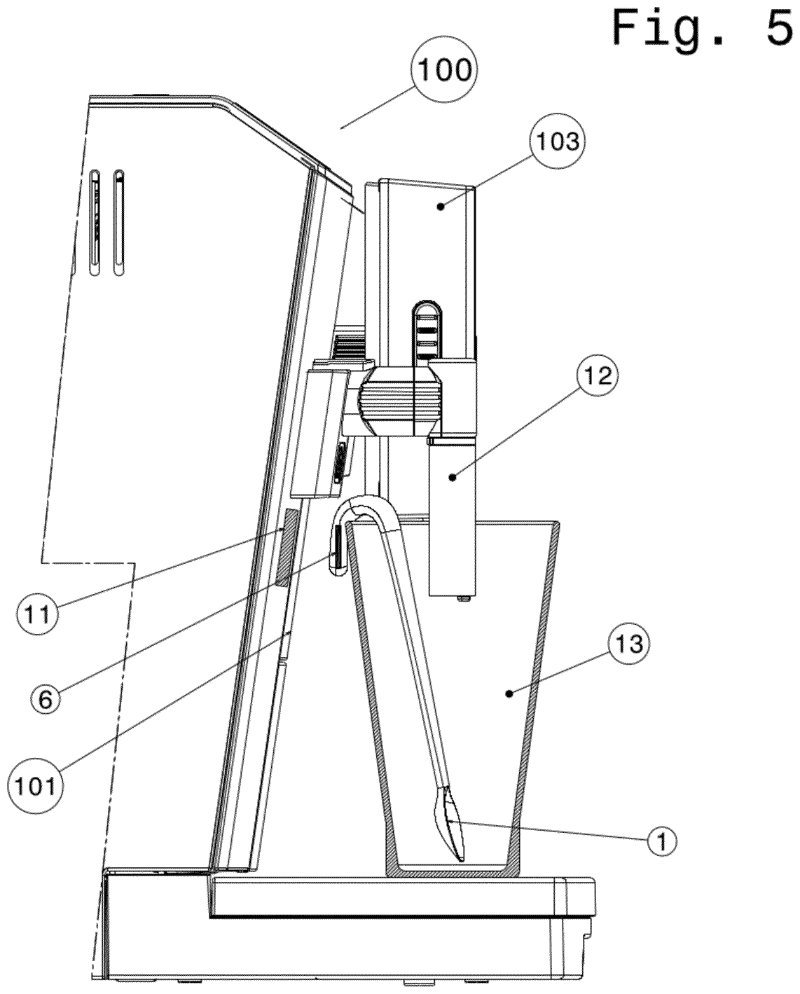

Advantageously, and alternatively, the longitudinal body 2 of the temperature probe 1, made of a flexible material that is plastically deformable, can be manually deformed in the upper portion 22 and, once bent into a hook shape, can be freely hooked on the edge of the container 13 and inserted inside the container 13, i.e. in the liquid contained therein, as shown in FIG. 5.

The appropriately dimensioned RFID transmission technology and the in any case modest relative distances in all cases ensure the exchange of information between the probe 1 and the machine body 100 via the respective second antenna 6 and the first antenna 11.

The temperature sensor 9 is advantageously positioned at the lower portion 20 of the longitudinal body 2, but in a longitudinally retracted position from the lower end 21, advantageously configured as a tool for other obvious purposes, not described herein, thus guaranteeing the detection of the temperature in the body of the liquid in the container 13 and not on the bottom or wall of the container itself, where the reading might be altered.

The temperature detected by the temperature sensor 9 is, via the microprocessor 8, the transponder 7 and the second antenna 6 configured on the electronic board 3 sealed inside the longitudinal body 2 of the temperature probe 1, transmitted wirelessly with RFID technology to the first antenna 11 positioned on the front wall 101: the signal is then processed by appropriate processing means inside the machine body 100 and the consequent instructions are sent from the control means to the production means and the dispensing means of the machine 100, not illustrated herein.

By way of example, by inserting the probe 1 into the liquid present in the container 13, a temperature detection is carried out as well as a check that the temperature is within the expected range for making the beverage according to predefined characteristics; in the event of a non-conforming reading, by way of example, dispensing of the beverage can be advised against, or the production cycle and/or the dispensing of the beverage can be differently regulated.

In a case where a temperature of a liquid in the container 13 is detected, for example frothed milk mounted using a steam dispensing wand 12, or equivalent means, the processing, control and production means, by organically interacting, bring the milk temperature to the programmed temperature.

As shown in FIG. 3, it is advantageously possible to insert the probe 1 in the liquid dispensed by the beverage dispenser 103 into the container 13 and by detecting the temperature of the liquid dispensed it is possible to adequately intervene on the production means and dispensing means thereof.

The acquisition of the temperatures of the dispensed liquids, which is automatically recordable by the processing means, can be used both for a self-diagnosis of the production machine 100 and for learning and memorization for a particular preparation, for example with new and different qualities of infusions.

It has been practically established how a machine for preparing beverages according to the invention is particularly advantageous for the simple and immediate detection of the temperature of a liquid in a container housed on a base thereof, both before and during and after making the beverage, by acquiring the information automatically and transmitting the information to the machine body using RFID type wireless technology, therefore without cables, thus enabling, through the memorization and processing of the information on the temperature, control and management of the production means of the beverage.

Naturally, modifications and variants of a machine for preparing beverages as described above are possible, all falling within the scope of the inventive concept; moreover, all the details are replaceable by technically equivalent elements.

In practice, the materials used, as well as the dimensions, and wireless transmission means can be any according to the needs and the state of the art.

1. A machine for preparing beverages comprising:
a front wall having a beverage dispenser and a steam dispenser,
a first antenna supported by the front wall,
a rest base for containers positioned in front of said front wall below said beverage dispenser and said steam dispenser, and
a temperature detection probe immersible in a comestible liquid contained in a container positioned on said rest base, wherein said temperature detection probe comprises a second antenna interacting with said first antenna for wireless transmission of the detected temperature of the liquid in the container.

2. The machine for preparing beverages according to claim 1, wherein said temperature detection probe comprises a longitudinal body that incorporates a temperature sensor, a microprocessor and a passive transponder including said second antenna.

3. The machine for preparing beverages according to claim 1, wherein said temperature sensor, said microprocessor and said passive transponder including said second antenna are supported by a printed interconnection circuit.

4. The machine for preparing beverages according to claim 1, wherein said printed interconnection circuit, said temperature sensor, said microprocessor and said passive transponder are sealed inside said longitudinal body.

5. The machine for preparing beverages according to claim 1, wherein said longitudinal body of said temperature detection probe is made of a flexible material that is plastically deformable.

6. The machine for preparing beverages according to claim 1, wherein said printed interconnection circuit is made of a flexible material that is plastically deformable.

7. The machine for preparing beverages according to claim 1, wherein said longitudinal body has a lower end and an upper end, a lower portion including said lower end, and an upper portion including said upper end, said temperature sensor being positioned at said lower portion and said second antenna being positioned at said upper portion.

8. The machine for preparing beverages according to claim 1, wherein said longitudinal body has support means for supporting said temperature detection probe engageable with said front wall or with said container.

9. The machine for preparing beverages according to claim 8, wherein said support means disengageably hook manually to said front wall or to said container.

10. The machine for preparing beverages according to claim 9, wherein said support means are magnetic or mechanical.

11. The machine for preparing beverages according to claim 8, wherein when said temperature detection probe is in use, said support means positions said second antenna outside said container.

12. The machine for preparing beverages according to claim 1, wherein, when said temperature detection probe is in use, said second antenna faces said first antenna.

13. The machine for preparing beverages according to claim 1, wherein said first antenna is in an interposed position between said beverage dispenser and said steam dispenser.

14. The machine for preparing beverages according to claim 7, wherein said temperature sensor is in a longitudinally retracted position from said lower end.

15. The machine for preparing beverages according to claim 1, wherein said lower end, said longitudinal body has a tool configuration.

16. The machine for preparing beverages according to claim 1, wherein said first antenna is positioned at a greater height than the tallest container positionable on said rest base for cups, beneath said beverage dispenser.
